(19) United States
(12) Patent Application Publication
(10) Pub. No.: US 2010/0119868 A1
(43) Pub. Date: May 13, 2010

(54) PLATED MEMBER AND METHOD FOR MANUFACTURING THE SAME

(75) Inventors: Takashi Nomura, Toyota-shi (JP); Yasuhumi Shibata, Anjou-shi (JP); Shigeru Konda, Kariya-shi (JP); Mitsuru Sakano, Toyota-shi (JP)

Correspondence Address: SUGHRUE MION, PLLC, 2100 PENNSYLVANIA AVENUE, N.W., SUITE 800, WASHINGTON, DC, 20037, US

(73) Assignee: Toyota Jidosha Kabushiki Kaisha, Toyota-shi, Aichi (JP)

(21) Appl. No.: 12/595,730

(22) PCT Filed: Apr. 18, 2008
(86) PCT No.: PCT/JP2008/057995

§ 371 Date: Oct. 13, 2009

(30) Foreign Application Priority Data
Apr. 25, 2007 (JP) 2007-115904

(51) Int. Cl. B32B 15/01; B32B 15/20; B05D 1/36

(52) U.S. Cl. 428/646; 428/615; 428/674; 427/405

(57) ABSTRACT

According to the present invention, in order to suppress whisker formation on a plated member having a plated layer comprising a lead-free material, the orientation index of the plane (321) in a plated layer for a plated member 3 having a plated layer 2 comprising a lead-free material on the surface of a base material 1 is 2.5 to 4.0. In another embodiment, the value (220)/(321) derived from the ratio of the orientation index of the plane (220) to that of the plane (321) for the plated layer is 0.5 to 1.5. An undercoat layer 4 having the orientation plane (220) may be formed between the base material 1 and the plated layer 2.

### TECHNICAL FIELD

The present invention relates to a plated member and a method for manufacturing the same. In particular, the present invention relates to a plated member having a plated layer on the surface thereof, such as an external terminal used for an electronic part such as a semiconductor device comprising a lead frame having an IC chip installed thereon, and a method for manufacturing the same.

### BACKGROUND ART

An electronic part such as a semiconductor device comprises an external terminal having a base material comprising copper, a copper alloy, brass, 42 alloy (alloy of iron and Ni (42%)), or the like. However, the untreated metal surface of such a terminal is oxidized. This can cause failures in soldering and the like, resulting in poor conduction. Hence, in general, treatment such as plating is carried out to form a protective film (plated layer) on the terminal surface in order to prevent oxidation.

Sn alloys containing lead have been conventionally used as plated layer materials. In recent years, it is required to use lead-free alloys in consideration of reduction in environmental burdens. Also, a lead-free material such as an Sn, Sn—Cu, Sn—Bi, or Sn—Ag alloy is becoming used as a plated layer material for a terminal as described above. However, when the terminal surface of an electronic part is plated with a lead-free material, whiskers (e.g., Sn single needle crystals) are formed on a plated layer.

In recent years, it has been required to further downsize electronic parts such as semiconductor devices comprising lead frames having IC chips installed thereon. As a result, the inter-terminal distance has been narrowed to approximately several hundred micrometers. The aforementioned whiskers grow to have lengths of several hundred micrometers in some cases. Therefore, as in the above case in which the inter-terminal distance is as narrow as several hundred micrometers, inter-terminal short circuits might be caused by formed whiskers. Therefore, it has been necessary to find a way to suppress whisker formation.

There have been many suggestions for such suppression. For instance, Patent Document 1 describes that whisker formation on a plated layer can be suppressed by increasing the crystal grain size of crystal particles constituting a plated layer so as to minimize grain boundaries observed in a unit volume of the plated layer when forming a lead-free Sn plated layer on the surface of a lead base material constituting an external terminal of an electronic part.

Meanwhile, Patent Documents 2 and 3 describe techniques for controlling the orientation index of a plane with a certain crystal orientation in a plated layer in order to prevent reduction in solder wettability upon formation of a lead-free Sn—Ag alloy plating film (plated layer) or improve the strength on a bonding plane.

### [Patent Document 1] JP Patent Publication (Kokai) No. 2005-86158 A

### [Patent Document 2] JP Patent Publication (Kokai) No. 2003-129284 A

### [Patent Document 3] JP Patent Publication (Kokai) No. 2005-123598 A

### DISCLOSURE OF THE INVENTION

### Problem to be Solved by the Invention

The present inventors have conducted many experiments and studies for methods for suppressing whisker formation on lead-free plated layers. However, it is difficult to say that sufficient effects can be obtained by any of the conventionally suggested methods for suppressing whisker formation. Therefore, it is empirically known that such methods still need to be improved.

The present invention has been made in view of the above circumstances. It is an object of the present invention to provide a plated member having a plated layer comprising a lead-free material, on which whisker formation can be suppressed by a novel method that has been conventionally unknown. It is another object of the present invention to provide a method for manufacturing such plated member.

### Means for Solving Problem

In order to achieve the above objects, the present inventors have further conducted experiments and studies and found the following new fact. It becomes possible to substantially completely suppress whisker formation on a plated layer by selecting a crystal orientation plane and appropriately controlling the orientation index of the selected plane on the plated layer in accordance with a method for controlling the orientation index of a crystal orientation plane on the surface of a plated layer that has been conventionally suggested in order to improve solder wettability or the like.

The present invention has been made based on the above findings. A plated member obtained in a first embodiment of the present invention has a plated layer comprising a lead-free material on the surface of a base material thereof. It is characterized in that the orientation index of the plane (321) in the plated layer is 2.5 to 4.0.

A plated member obtained in a second embodiment of the present invention has a plated layer comprising a lead-free material on the surface of a base material thereof. It is characterized in that the value (220)/(321) derived from the ratio of the orientation index of the plane (220) to that of the plane (321) for the plated layer is 0.5 to 1.5.

Regarding the plated members in the 1^{st} and 2^{nd} embodiments, Sn, Zn, or an alloy containing either thereof as a first material is used as a lead-free material that constitutes a plated layer. Preferably, a plating material is pure Sn or an Sn alloy such as an Sn—Cu, Sn—Bi, or Sn—Ag alloy. In particular, an Sn—Cu alloy is preferable. Cu or a Cu alloy is preferably used for the base material.

Preferably, the base material has the orientation plane (220) on the surface thereof. Alternatively, an undercoat layer having the orientation plane (220) may be formed between the surface of a base material and a plated layer. Accordingly, a plated layer having the above orientation plane can be readily obtained.

In one embodiment of the method for manufacturing a plated member of the present invention whereby the above plated member can be manufactured, the method comprises the 1^{st} step of allowing the surface of a base material to have the crystal orientation plane (220) and the 2^{nd} step of carrying out plating on the surface of the base material. As described in Examples below, crystal orientation in a plated layer can be controlled in a desired manner by allowing the surface of a base material to have the crystal orientation plane (220). In the above manufacturing method, the 1^{st} step may include a step of forming an undercoat layer controlled so that it has the crystal orientation plane (220) on the surface of a base material. The formation of such an undercoat layer can be carried out by, for example, providing an undercoat plated layer or a vapor-deposited film, in which crystal orientation is observed. According to the above method, a desirable orientation can be realized on the plated surface even when the crystal orientation plane on the surface of a base material cannot be controlled. It is effective to use, as an undercoat layer, a layer comprising Ni, Ag, Au, Pd, or the like. For preparation of an undercoat layer, methods involving sputtering, PLD, CVD, PVD, MBE, and the like can be used. Also, electroplating can be applied.

According to the present invention, it is possible to substantially completely suppress whisker formation on a plated layer that constitutes a plated member obtained by forming a plated layer comprising a lead-free material on the surface of a base material. Therefore, in the case of the plated member of the present invention, the inter-terminal distance is narrowed to several hundred micrometers. For example, the plated member can be preferably used for a terminal portion of a member comprising a lead frame having an IC chip installed thereon.

### BRIEF DESCRIPTION OF THE DRAWINGS

FIG. 1 is a schematic view of an example of the plated member of the present invention.

FIG. 2 is a schematic view of another example of the plated member of the present invention.

### EXPLANATION OF REFERENCE NUMERALS

1 . . . Base material, 2 . . . Plated layer, 3 . . . Plated member, 4 . . . Undercoat layer

### EXAMPLES

Hereinafter, the present invention is described based on the Examples and the Comparative Examples.

### Example 1

### Examples and Comparative Examples in the 1^{st} Embodiment

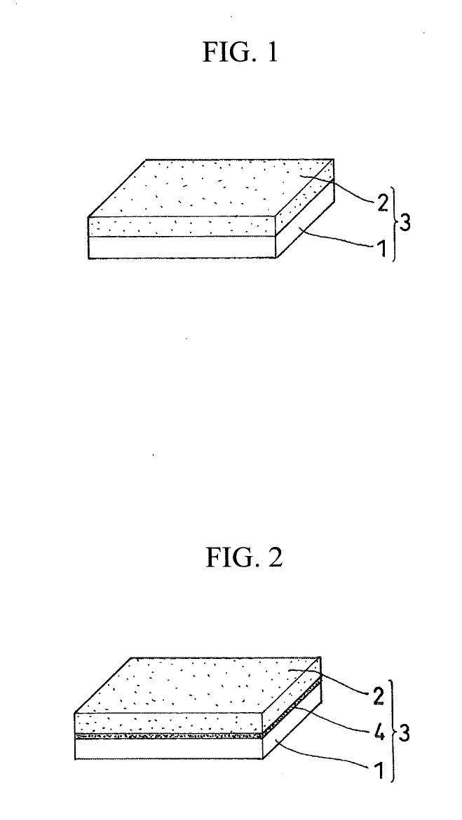

As shown in FIG. 1, a plated layer 2 comprising an Sn—Cu alloy was formed on the surface of a base material 1 comprising a Cu alloy such that a test plated member 3 was prepared. At such time, a plurality of plated members each composed of a plated layer 2 having the crystal orientation plane (321) with an orientation index of 1.17 to 8.27 were manufactured. Each member was subjected to an isothermal standing-still test (test 1) involving standing still at an isothermal temperature of 25° C., 55° C., or 85° C. for 2000 hours (H) and a thermal cycle test (test 2) involving the repetition of a thermal cycle of −40° C. to 85° C. or 0° C. to 60° C. (2000 cycles in total). The occurrence or nonoccurrence of whisker formation was observed with a scanning electron microscope. Table 1 shows the results.

TABLE 1

| Orientation | | | | | |
|---|---|---|---|---|---|
| index of | Test 1: Isothermal standing | | | Test 2: Thermal cycle | |
| the (321) | still (2000 H) | | | (2000 cycles) | |
| plane | 25° C. | 55° C. | 85° C. | −40° C. [symbol] 85° C. | 0° C. [symbol] 60° C. |
| 1.17 | Not formed | Not formed | Not formed | Formed | Formed |
| 1.69 | Not formed | Not formed | Not formed | Formed | Formed |
| 2.98 | Not formed | Not formed | Not formed | Not formed | Not formed |
| 3.47 | Not formed | Not formed | Not formed | Not formed | Not formed |
| 4.61 | Formed | Formed | Formed | Formed | Formed |
| 8.27 | Formed | Formed | Formed | Formed | Formed |

In addition, the orientation index was calculated by X-ray diffraction.

### [Evaluation]

Whisker formation was observed on a plated member having the plane (321) with an orientation index of 1.17 and that with an orientation index of 1.69 during the thermal cycle test, but not during the isothermal standing-still test. Meanwhile, whisker formation was observed on a plated member having the plane (321) with an orientation index of 4.61 and that with an orientation index of 8.27 during both of the isothermal standing-still test and the thermal cycle test. On the other hand, whisker formation was not observed on a plated member having the plane (321) with an orientation index of 2.98 and that with an orientation index of 3.47 (corresponding to the Examples of the present invention) during both of the isothermal standing-still test and the thermal cycle test. Accordingly, it is understood that a plated member free from whisker formation can be obtained by allowing a plated layer comprising a lead-free material to have the plane (321) with an orientation index of 2.5 to 4.0.

### Example 2

### Examples and Comparative Examples in the 2^{nd} Embodiment

As in the case of Example 1, a plated layer 2 comprising an Sn—Cu alloy was formed on the surface of a base material 1 comprising a Cu alloy such that a test plated member 3 was prepared. At such time, a plurality of plated members each having a value (220)/(321) (derived from the ratio of the orientation index of the plane (220) to that of the plane (321) for a plated layer) of 0.007 to 3.43 were manufactured. Each member was subjected to an isothermal standing-still test (test 1) and a thermal cycle test (test 2). The occurrence or nonoccurrence of whisker formation was observed with a scanning electron microscope. Table 2 shows the results.

TABLE 2

| Orientation | Test 1: Isothermal standing | | | Test 2: Thermal cycle | |
|---|---|---|---|---|---|
| index ratio | still (2000 H) | | | (2000 cycles) | |
| (220)/(321) | 25° C. | 55° C. | 85° C. | −40° C. [symbol] 85° C. | 0° C. [symbol] 60° C. |
| 0.007 | Formed | Formed | Formed | Formed | Formed |
| 0.450 | Formed | Formed | Formed | Formed | Formed |
| 0.795 | Not formed | Not formed | Not formed | Not formed | Not formed |
| 1.007 | Not formed | Not formed | Not formed | Not formed | Not formed |
| 2.170 | Not formed | Not formed | Not formed | Formed | Formed |
| 3.430 | Not formed | Not formed | Not formed | Formed | Formed |

Herein, the orientation index was calculated in the same manner as in Example 1.

### [Evaluation]

Whisker formation was observed on a plated member having a value (220)/(321) (derived from the orientation index ratio) of 0.007 and that having such a value of 0.45 during both of the isothermal standing-still test and the thermal cycle test. Meanwhile, whisker formation was observed on a plated member having a value derived from the orientation index ratio of 2.17 and that having such a value of 3.43 during the thermal cycle test, but not during the isothermal standing-still test. However, whisker formation was not observed on a plated member having a value derived from the orientation index ratio of 0.795 and that having such a value of 1.007 during both of the isothermal standing-still test and the thermal cycle test. Accordingly, it is understood that a plated member free from whisker formation can be obtained by allowing a plated layer comprising a lead-free material to have a value (220)/(321) (derived from the ratio of the orientation index of the plane (220) to that of the plane (321)) of 0.5 to 1.5.

### Example 3

As in the case of Example 1, a plated layer 2 comprising an Sn—Cu alloy was formed on the surface of a base material 1 comprising a Cu alloy such that a test plated member 3 was prepared. At such time, the surface of a base material 1 comprising a Cu alloy was allowed to have the orientation plane (220) or the orientation plane (200). An electroplated layer 2 comprising an Sn—Cu alloy was formed on the surface of each of the thus obtained two base materials 1 each comprising a Cu alloy. Each plated layer 2 was subjected to measurement of the orientation index of the plane (321) and that of the plane (220) in the same manner as in Example 1. Then, the value (220)/(321) derived from the ratio of the orientation index of the plane (220) to that of the plane (321) was obtained. Table 3 shows the results.

TABLE 3

| | | Orientation | Value (220)/(321) |
|---|---|---|---|
| Base material | Orientation index | index of the | derived from the |
| surface | of the plane (321) | plane (220) | orientation index ratio |
| Orientation | 3.47 | 2.76 | 0.795 |
| plane (220) | | | |
| Orientation | 4.61 | 2.08 | 0.451 |
| plane (200) | | | |

### [Evaluation]

As shown in table 3, it was possible to control the orientation indices of the plane (321) and the plane (220) in an electroplated layer 2 by controlling the orientation plane on the surface of an alloy base material 1. In addition, in a case in which the surface of a base material was allowed to have the orientation plane (220), it was found possible to obtain a plated member with the orientation index of the plane (321) in a plated layer 2 and the value (220)/(321) derived from the ratio of the orientation index of the plane (220) to that of the plane (321) that fell within the scope of the present invention. In a case in which the surface of a base material was allowed to have the orientation plane (220), the orientation index of the plane (321) in a plated layer 2 and the value (220)/(321) derived from the ratio of the orientation index of the plane (220) to that of the plane (321) did not fall within the scope of the present invention. Thus, it has been found that it is effective to allow the surface of an alloy base material 1 comprising to have the orientation plane (220) in a method for obtaining the plated member of the present invention.

### Example 4

As in the case of Example 1, a plated layer 2 comprising an Sn—Cu alloy was formed on the surface of a base material 1 comprising a Cu alloy such that a test plated member 3 was prepared. At such time, the orientation index of the plane (321) in a plated layer 2 was controlled by heat treatment.

### Example 4-1

Heat treatment was carried out at a temperature of 100° C., 125° C., 150° C., or 200° C. for 20 hours (H). Table 4 shows orientation indices of the plane (321) obtained before and after heat treatment.

TABLE 4

| | Orientation index of the | Orientation index of the |
|---|---|---|
| Heat treatment | plane (321) before heat | plane (321) after heat |
| temperature (20 H) | treatment | treatment |
| 100° C. | 4.47 | 4.21 |
| 125° C. | 4.47 | 2.98 |
| 150° C. | 4.47 | 2.71 |
| 200° C. | 4.47 | Unmeasurable due to |
| | | phase transition |

### Example 4-2

Heat treatment was carried out at a temperature of 125° C. for 10 hours (H), 20 hours (H), 40 hours (H), and 60 hours (H). Table 5 shows orientation indices of the (321) plane obtained before and after heat treatment.

TABLE 5

| Time | Orientation index of the | Orientation index of the |
|---|---|---|
| (temperature | plane (321) before heat | plane (321) after heat |
| 125° C.) | treatment | treatment |
| 10 H | 4.47 | 4.15 |
| 20 H | 4.47 | 2.98 |
| 40 H | 4.47 | 2.85 |
| 60 H | 4.47 | 4.08 |

### [Evaluation]

As shown in tables 4 and 5, the orientation index of the plane (321) in a plated layer was 4.47 before heat treatment. Therefore, it has been found that an appropriate heat treatment allowed a plated member that had not been encompassed by the present invention to have the orientation index of the plane (321) that fell within the scope of the present invention. Accordingly, it is understood that a heat treatment is an effective control means for obtaining the plated member of the present invention.

### Example 5

As shown in FIG. 2, an Ni undercoat layer 4 having the orientation plane (220) was formed on the surface of a base material 1 comprising a Cu alloy and having no specific orientation plane on the surface thereof by sputtering. As in the case of Example 1, an Sn—Cu plated layer 2 was formed on an Ni undercoat layer 4 such that a plated member 3 was prepared. The orientation index of the plane (321) in the plated layer was measured in the same manner as in Example 1. For a Comparative Example, an Sn—Cu plated layer 2 was directly formed on the surface of a base material 1 comprising a Cu alloy and having no undercoat layer formed thereon. Thus, a plated member was prepared. The orientation index of the plane (321) in the plated layer was measured in the same manner as in Example 1. Table 6 shows the results.

TABLE 6

| | | Orientation index |
|---|---|---|
| Base material | Undercoat layer | of the plane (321) |
| orientation | orientation | in a plated layer |
| None | 220 | 3.27 |
| None | No undercoat layer | 4.61 |

### [Evaluation]

As shown in table 6, in the case in which a base material had no orientation plane, the orientation index of the plane (321) of a plated layer was 4.61, which did not fall within the scope of the present invention. However, in the case in which an undercoat layer having the orientation plane (220) was formed on the surface of a base material, the orientation index of the plane (321) in a plated layer was 3.27, which successfully fell within the scope of the present invention. Accordingly, it has been found that it is effective to form an undercoat layer having a specific orientation plane on the surface of a base material such that the plated member of the present invention can be obtained.

1. A plated member having a plated layer comprising a lead-free material on the surface of a base material thereof, characterized in that the orientation index of the plane (321) in the plated layer is 2.5 to 4.0.

2. A plated member having a plated layer comprising a lead-free material on the surface of a base material thereof, characterized in that the value (220)/(321) derived from the ratio of the orientation index of the plane (220) to that of the plane (321) for the plated layer is 0.5 to 1.5.

3. The plated member according to claim 1, wherein a plated layer constituent is Sn and/or an Sn alloy.

4. The plated member according to claim 3, in which the Sn alloy is an Sn—Cu alloy.

5. The plated member according to claim 1, in which the base material is Cu or a Cu alloy.

6. The plated member according to claim 1, in which the base material has the orientation plane (220) on the surface thereof.

7. The plated member according to claim 1, in which an undercoat layer having the orientation plane (220) is formed between the surface of a base material and a plated layer.

8. A method for manufacturing a plated member of claim 1, comprising the 1^{st} step of allowing the surface of a base material to have the crystal orientation plane (220) and the 2^{nd} step of carrying out plating on the surface of the base material.

9. The method for manufacturing a plated member according to claim 8, wherein the 1^{st} step includes a step of forming an undercoat layer controlled so that it has the crystal orientation plane (220) on the surface of a base material.
